(19) United States
(12) Patent Application Publication
(10) Pub. No.: US 2026/0236244 A1
(43) Pub. Date: Aug. 13, 2026

(54) TECHNIQUES FOR CREATION OF ARTIFICIAL INTELLIGENCE APPLICATIONS

(71) Applicant: DataRobot, Inc., Boston, MA (US)

(72) Inventors: Ina Ko, Old Bridge, NJ (US); Lukas Innig, St. Albans (GB); Marcus Braun, Minneapolis, MN (US); Mark L. Steadman, Watertown, MA (US); Michael Schmidt, Washington, DC (US); Marshall Philip Krassenstein, Pittsburgh, PA (US); Carson Gee, Boston, MA (US)

(73) Assignee: DataRobot, Inc., Boston, MA (US)

(21) Appl. No.: 19/535,981

(22) Filed: Feb. 10, 2026

Related U.S. Application Data
(60) Provisional application No. 63/756,728, filed on Feb. 10, 2025.

(51) Int. Cl. G06F 8/60; G06F 8/61; G06F 8/65; G06F 8/71

(52) U.S. Cl. CPC G06F 8/60; G06F 8/61; G06F 8/65; G06F 8/71

(57) ABSTRACT

A computer-implemented technique for creating and deploying an application receives a configuration file selecting a subset of preconfigured application bundles and associated configuration values. A template instance is generated to identify the selected bundles and define dependency relationships among the selected bundles. Based on the dependency relationships, an execution plan is determined to order provisioning and deployment actions. Execution resources in a deployment environment are provisioned according to the execution plan. For each selected bundle, a managed bundle object including executable logic and runtime configuration is created and deployed as a corresponding bundle endpoint. Communication between endpoints is configured by propagating an identifier of an upstream bundle endpoint into a runtime configuration of a dependent bundle endpoint. An application endpoint is exposed to receive a request and invoke at least one bundle endpoint to generate a response.

### CROSS-REFERENCE TO RELATED APPLICATIONS

The present disclosure claims the benefit of U.S. Provisional Patent Application No. 63/756,728, filed February 10, 2025, titled “Techniques for Creation of Artificial Intelligence Applications,” the entire contents of which are incorporated by reference herein.

### TECHNICAL FIELD

The present disclosure relates to artificial intelligence (AI) application development, and more particularly to techniques for the creation of applications that incorporate AI models.

### BACKGROUND

AI technologies have become increasingly integrated into software applications across diverse industries, including healthcare, finance, manufacturing, and entertainment. Generative artificial intelligence (generative AI or Gen AI), a subset of AI technology, has the capability to generate new and original content, including text, imagery, audio, source code, and synthetic data, by utilizing AI algorithms and advanced neural networks such as large language models (LLMs) and transformer-based architectures. Generative AI enables machines to engage in creative content generation by analyzing patterns in training data and producing outputs that share characteristics with that training data.

### BRIEF DESCRIPTION OF THE DRAWINGS

Certain features of the subject technology are set forth in the appended claims. However, for the purpose of explanation, several embodiments of the subject technology are set forth in the following figures, where like reference numerals refer to the same or similar features in the various figures.

FIG. 1 is a block diagram of a core system architecture including five facilities, according to one or more embodiments.

FIG. 2 is a block diagram of a template including a configuration file and an initialization script, according to one or more embodiments.

FIG. 3 is a flow diagram illustrating an initial deployment workflow executed using the initialization script, according to one or more embodiments.

FIG. 4 is a flow diagram illustrating an update handling workflow executed using the initialization script, according to one or more embodiments.

FIG. 5 is a block diagram of a retrieval-augmented generation (RAG) application architecture, according to one or more embodiments.

FIG. 6 is a dependency graph for an application based on the architecture of FIG. 5, according to one or more embodiments.

FIG. 7 is a block diagram of a forecasting application architecture, according to one or more embodiments.

FIG. 8 is a dependency graph for an application based on the architecture of FIG. 7, according to one or more embodiments.

FIG. 9 is a block diagram of a content generation application architecture, according to one or more embodiments.

FIG. 10 is dependency graph for an application based on the architecture of FIG. 9, according to one or more embodiments.

FIG. 11 is a block diagram of an example computing device, according to one or more embodiments.

### DETAILED DESCRIPTION

### Generative AI (“Gen AI”) and Deep Learning (DL)

Gen AI technology generally utilizes generative models such as Generative Adversarial Networks (GANs), transformer-based models, diffusion models (e.g., stable diffusion models), and/or Variational Autoencoders (VAEs), etc., which are based on artificial neural networks and deep learning. Deep Learning (DL) is a subset of machine learning (“ML”) that focuses on artificial neural networks (ANN) and their ability to learn and make decisions. Deep Learning involves the use of complex algorithms to train ANNs to recognize patterns and make predictions based on large amounts of data. The key difference between DL and traditional ML algorithms is that DL algorithms can learn multiple layers of representations, allowing them to model highly nonlinear relationships in the data. This makes them particularly effective for applications such as image and speech recognition, natural language processing (NLP), etc.

Most DL methods use ANN architectures, which is why DL models are often referred to as deep neural networks (DNNs). The term “deep” refers to the number of hidden layers in the neural network. For example, a traditional ANN may only contain 2-3 hidden layers, while DNNs can have as many as 150 layers (or more). DL uses these multiple layers to progressively extract higher-level features from the raw input. For example, in image processing, lower layers may identify edges, while higher layers may identify the concepts relevant to a human, such as digits, letters, or faces. DL models are trained by using large sets of labeled data and ANN architectures that learn features directly from the data without the need for manual feature extraction.

### Hyperparameters and Hyperparameter Tuning

Hyperparameters are external configuration variables that control or guide machine learning model training. In other words, hyperparameters are parameters that control the learning process and thereby influence the ultimate structure of the model and the learned values of the model parameters. Many hyperparameters are used to guide the training of DNNs, such as the size (number of layers and number of units per layer), the learning rate (e.g., a tuning parameter in an optimization algorithm that determines the step size at each iteration while moving toward a minimum of a loss function), and initial weights of model parameters.

The process of training an ANN involves choosing hyperparameter values that control and guide the learning algorithm. The process of experimenting with different hyperparameter values to find a suitable or optimum hyperparameter set is known as hyperparameter tuning or hyperparameter optimization. Hyperparameter tuning is an important aspect of developing ML tools and AI systems because the selected set of hyperparameters can have a significant impact on model performance and accuracy. For example, if the learning rate hyperparameter of an ANN training algorithm is too high, the model may converge too quickly with suboptimal results. On the other hand, if the learning rate is too low, training may take too long and results may not converge.

“Automated machine learning” (AutoML) technology may be used to automate significant portions of the process of developing ML tools and AI systems. For example, AutoML tools may assist with or control the hyperparameter tuning process.

### Large Language Models (LLM) and Transformer Networks

In many generative AI (Gen AI) systems, the generative model that generates content is a large language model (LLM). An LLM is a type of ML model that can perform a variety of natural language processing (NLP) tasks such as generating and classifying text, answering questions in a conversational manner, and translating text from one language to another. The term “large” refers to the number of values (parameters) the language model can change autonomously as it learns. Some LLMs have hundreds of billions of parameters. In general, LLMs are NN models that have been trained using deep learning techniques to recognize, summarize, translate, predict, and generate content using very large datasets.

Many state-of-the-art LLMs use a class of deep learning architectures called transformer neural networks (“transformer networks” or “transformers”). A transformer is a neural network that learns context and meaning by tracking relationships between data units, such as the words in a sentence. A transformer can include multiple transformer blocks, also known as layers. For example, a transformer may have self-attention layers, feed-forward layers, and normalization layers, all working together to decipher input to predict (or generate) streams of relevant output. The layers can be stacked to make deeper transformers and powerful language models.

Two innovations that make transformers adept for large language models: positional encodings and self-attention. Positional encoding embeds the order in which the input occurs within a given sequence. Rather than feeding words within a sentence sequentially into the neural network, with positional encoding, the words can be fed in non-sequentially. Self-attention assigns a weight to each part of the input data while processing it. This weight signifies the importance of that portion of the input in the context of the rest of the input. The use of the attention mechanism enables models to focus on the parts of the input that matter the most. This representation of the relative importance of different inputs to the neural network is learned over time as the model sifts and analyzes data. These two techniques in conjunction allow for analyzing the subtle ways and contexts in which distinct elements influence and relate to each other over long distances, non-sequentially. The ability to process data non-sequentially enables the decomposition of the complex problem into multiple, smaller, simultaneous computations.

“Text completion” may refer to the process of a generative model generating additional text based on provided text, e.g., providing the next word in a sentence. The additional text provided by the generative model may be referred to herein as a “completion.” More generally, completions generated by generative models may include text, audio data (e.g., speech, music, etc.), image data (e.g., images), video data (e.g., videos), time-series data, or any other suitable type of data. “Prompting” may refer to a technique in which a generative model (e.g., an LLM) is matched to a desired downstream task by formulating the task as natural language text explaining the desired behavior, such that a generative model can carry out the task by performing text completion. Often these instructions are split into a “system message” containing general task instructions providing general guidance about the desired behavior and a “prompt template” containing the portion of the prompt that contains indicator values that are substituted in each use. “Fine-tuning” may refer to the process whereby a generative model is adapted to a particular task by changing its parameters by providing prompts with desired completions.

Generative AI models can analyze existing content, identify patterns in the content, and combine or modify the identified patterns to generate new content. The new content can include text, images, video, music, or any other suitable type of content. Some non-limiting examples of generative AI models include generative adversarial networks (GANs), variational autoencoders (VAEs), autoregressive models (e.g., large language models (LLMs)), recurrent neural networks (RNNs), transformer-based models, reinforcement learning models for generative tasks, etc. Transformer-based models generally have an encoder-decoder architecture, use an attention mechanism (e.g., scaled dot-product attention, multi-head attention, masked attention, etc.) to model the relationships between different elements in a sequence of content, and perform well when processing long sequences of content. Some non-limiting examples of transformer-based models include Generalized Pre-trained Transformer 4 (GPT-4), DALL-E3, etc. Other examples of generative models with text-processing capability include Jurassic-1, Command, and Paradigm. Generative models can benefit from hyperparameter tuning to tweak the model’s performance for desired results, as discussed above.

### Terms

Many of the examples and embodiments disclosed herein are described with respect to a knowledge base. However, the techniques described herein can be applied to any type of “grounding data” for generative AI systems (e.g., retrieval-augmented generation (RAG) -based generative AI systems) including but not limited to knowledge bases and/or other information sources.

The term “generative model” as used herein may generally refer to a type of machine learning model that is trained on existing data to enable the generative model to generate, based on an input or prompt, new data that shares characteristics similar to that of the training data. In some examples, a generative model may handle text. In these examples, the generative model may accept text prompts and produce text outputs. Any suitable type of AI model can be used, including predictive models, generative AI (“Gen AI”) models, etc. Predictive models can analyze historical data, identify patterns in that data, and make inferences (e.g., produce predictions or forecast outcomes) based on the identified patterns. Some non-limiting examples of predictive models include neural networks (e.g., deep neural networks (DNNs), convolutional neural networks (CNNs), recurrent neural networks (RNNs), learning vector quantization (LVQ) models, etc.), regression models (e.g., linear regression models, logistic regression models, linear discriminant analysis (LDA) models, etc.), decision trees, random forests, support vector machines (SVMs), naïve Bayes models, classifiers, etc.

As used herein, “data analytics” may refer to the process of analyzing data (e.g., using machine learning models or techniques) to discover information, draw conclusions, and/or support decision-making. Species of data analytics can include descriptive analytics (e.g., processes for describing the information, trends, anomalies, etc. in a dataset), diagnostic analytics (e.g., processes for inferring why specific trends, patterns, anomalies, etc. are present in a dataset), predictive analytics (e.g., processes for predicting future events or outcomes), and prescriptive analytics (processes for determining or suggesting a course of action).

“Machine learning” may refer to the application of certain techniques (e.g., pattern recognition and/or statistical inference techniques) by computer systems to perform specific tasks. Machine learning techniques (automated or otherwise) may be used to build data analytics models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference dataset.

A feature of a data sample may be a measurable property of an entity (e.g., person, thing, event, activity, etc.) represented by or associated with the data sample. In some cases, a feature of a data sample is a description of (or other information regarding) an entity represented by or associated with the data sample. A value of a feature may be a measurement of the corresponding property of an entity or an instance of information regarding an entity. In some cases, a value of a feature can indicate a missing value (e.g., no value). For instance, in the above example in which a feature is the price of a house, the value of the feature may be “NULL”, indicating that the price of the house is missing.

Features can also have data types. For instance, a feature can have a numerical data type, a categorical data type, a time-series data type, a text data type (e.g., a structured text data type or an unstructured (“free”) text data type), an image data type, a spatial data type, or any other suitable data type. In general, a feature’s data type is categorical if the set of values that can be assigned to the feature is finite.

As used herein, “time-series data” may refer to data collected at different points in time. For example, in a time-series dataset, each data sample may include the values of one or more variables sampled at a particular time. In some embodiments, the times corresponding to the data samples are stored within the data samples (e.g., as variable values) or stored as metadata associated with the dataset. In some embodiments, the data samples within a time-series dataset are ordered chronologically. In some embodiments, the time intervals between successive data samples in a chronological time-series dataset are substantially uniform.

Time-series data may be useful for tracking and inferring changes in the dataset over time. In some cases, a time-series data analytics model (or “time-series model”) may be trained and used to predict the values of a target Z at time t and optionally times t+1, …, t+i, given observations of Z at times before t and optionally observations of other predictor variables P at times before t. For time-series data analytics problems, the objective is generally to predict future values of the target(s) as a function of prior observations of all features, including the targets themselves.

As used herein, “image data” may refer to a sequence of digital images (e.g., video), a set of digital images, a single digital image, and/or one or more portions of any of the foregoing. A digital image may include an organized set of picture elements (“pixels”). Digital images may be stored in computer-readable files. Any suitable format and type of digital image file may be used, including but not limited to raster formats (e.g., TIFF, JPEG, GIF, PNG, BMP, etc.), vector formats (e.g., CGM, SVG, etc.), compound formats (e.g., EPS, PDF, PostScript, etc.), and/or stereo formats (e.g., MPO, PNS, JPS, etc.).

As used herein, “non-image data” may refer to any type of data other than image data, including but not limited to structured textual data, unstructured textual data, categorical data, and/or numerical data. As used herein, “natural language data” may refer to speech signals representing natural language, text (e.g., unstructured text) representing natural language, and/or data derived therefrom. As used herein, “speech data” may refer to speech signals (e.g., audio signals) representing speech, text (e.g., unstructured text) representing speech, and/or data derived therefrom. As used herein, “auditory data” or “audio data” may refer to audio signals representing sound and/or data derived therefrom.

As used herein, “spatial data” may refer to data relating to the location, shape, and/or geometry of one or more spatial objects. A “spatial object” may be an entity or thing that occupies space and/or has a location in a physical or virtual environment. In some cases, a spatial object may be represented by an image (e.g., photograph, rendering, etc.) of the object. In some cases, a spatial object may be represented by one or more geometric elements (e.g., points, lines, curves, and/or polygons), which may have locations within an environment (e.g., coordinates within a coordinate space corresponding to the environment).

Data (e.g., variables, features, etc.) having certain data types, including data of the numerical, categorical, or time-series data types, are generally organized in tables for processing by machine-learning tools. Data having such data types may be referred to collectively herein as “tabular data” (or “tabular variables,” “tabular features,” etc.). Data of other data types, including data of the image, textual (structured or unstructured), natural language, speech, auditory, or spatial data types, may be referred to collectively herein as “non-tabular data” (or “non-tabular variables,” “non-tabular features,” etc.).

As used herein, “agentic application” may refer to an AI application in which one or more autonomous agents (e.g., software processes associated with an LLM) perform tasks, make decisions, and/or interact with external systems, tools, or other agents. Agentic applications may involve multi-agent orchestration, tool calling, memory management, and/or dynamic workflow execution.

As used herein, “Model Context Protocol” (MCP) may refer to a protocol for standardizing communication between AI agents and tools, including tool discovery, invocation, and response handling.

As used herein, “template instance” may refer to a customized representation of an application template generated based on user selections and configuration values and configured for execution to deploy an application.

As used herein, an “endpoint identifier” may refer to a network address, URI/URL, deployment handle, and/or other identifier usable to invoke a deployed bundle and/or establish communications with a bundle.

As used herein, an “execution graph” may refer to a directed representation of bundle endpoints and invocation paths derived from a template instance and usable to route a request through one or more bundle endpoints.

As used herein, “bundle-specific metrics” may refer to operational measurements collected for an individual managed bundle object, such as latency, error rate, invocation count, throughput, resource utilization, and/or cost.

As used herein, a “credentialed connection” may refer to an authenticated and authorized connection to an external data source using one or more credentials, such as an API token, service account credential, signed key, and/or delegated identity credential.

As used herein, “data analytics model” may refer to any suitable model artifact generated by the process of using a machine learning algorithm to fit a model to a specific training dataset. The terms “data analytics model,” “machine learning model” and “machine learned model” are used interchangeably herein.

As used herein, the “development” of a machine learning model may refer to construction of the machine learning model. Machine learning models may be constructed by computers using training datasets. Thus, “development” of a machine learning model may include the training of the machine learning model using a training dataset. In some cases (generally referred to as “supervised learning”), a training dataset used to train a machine learning model can include known outcomes (e.g., labels or target values) for individual data samples in the training dataset. For example, when training a supervised computer vision model to detect images of cats, a target value for a data sample in the training dataset may indicate whether or not the data sample includes an image of a cat. In other cases (generally referred to as “unsupervised learning”), a training dataset does not include known outcomes for individual data samples in the training dataset.

For generative artificial intelligence (GenAI) systems, development may further include processes, such as fine-tuning a pre-trained generative model on domain-specific corpora and/or task-specific exemplars; constructing and maintaining grounding data resources, such as a knowledge base (KB) and associated retrieval indices (e.g., document chunking, embedding generation, and vector database population) for retrieval-augmented generation; engineering prompts and/or prompt templates, including system messages, user-facing templates, and few-shot exemplars tailored to target tasks; engineering tool descriptions, input/output schemas, and invocation policies used by agentic applications to enable deterministic tool selection and safe execution; and configuring moderation, guardrail, and grading models (e.g., topicality, groundedness, toxicity, and refusal classifiers) that are used during inference and/or evaluation. In some embodiments, development activities may also include evaluation dataset construction, synthetic data generation, hyperparameter selection and tuning for both generative and retrieval components, and creation of deployment-ready artifacts (e.g., model weights, tokenizer configurations, prompt libraries, and KB manifests) to support reproducible, governed operation in production environments.

In some embodiments, development activities may also include evaluation dataset construction, synthetic data generation, hyperparameter selection and tuning for both generative and retrieval components, and creation of deployment-ready artifacts (e.g., model weights, tokenizer configurations, prompt libraries, and KB manifests) to support reproducible, governed operation in production environments

Following development, a machine learning model may be used to generate inferences with respect to “inference” datasets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

### Motivation for and Benefits of Some Embodiments

The present disclosure generally relates to artificial intelligence (AI), such as generative artificial intelligence (“generative AI” or “Gen AI”) and automated machine learning (“Auto ML”). Some aspects of the disclosure relate specifically to techniques for creation (e.g., rapid creation) of AI applications. Such techniques can encompass generation, development, integration, deployment, and/or any other suitable tasks involved in the creation of AI applications.

The software development process for AI applications may be dynamic and iterative encompassing multiple stages, such as data preparation, model development, validation, deployment, and maintenance. Compared to traditional software development, AI application development may involve a greater degree of experimentation and iterative refinement, as outcomes may depend on the quality and variability of input data and the behavior of machine learning models. Due to this dependence on experimentation, iterative refinement, and attributes of input data, developing AI applications and sustaining or improving their performance over time may involve repeated (e.g., continuous) evaluation and tuning.

Application development tasks may be grouped into distinct specialties, reflecting the diverse expertise utilized. Data science objectives may include extracting insights from data, building predictive models, and performing exploratory analyses. Data science tasks may include data cleaning, feature engineering, model selection, and hyperparameter tuning. Data scientists may work in development environments such as Jupyter Notebooks. Once a model is sufficiently trained, transitioning the model into a robust, production-ready application involves a different skill set focused on scalability, reliability, and integration into broader system architectures. Software development and/or IT operations (collectively referred to as “DevOps”) may include the reliable and scalable deployment of applications into production. DevOps tasks may include managing infrastructure, automating deployment pipelines, and monitoring performance of applications. DevOps practices may emphasize robustness, reproducibility, and operational efficiency, leveraging tools for infrastructure as code (e.g., Terraform or Pulumi) and containerization (e.g., Docker) to deploy applications into production within a cloud-based or on-premises infrastructure.

The challenges of AI application development and deployment workflows may be numerous. First, there may be a disconnect between an experimentation phase, which may prioritize flexibility and rapid iteration, and a deployment phase, which may prioritize stability and precision. Second, the integration of AI models into applications may rely on carefully configured hyperparameters, infrastructure settings, dependencies, and/or the like. Developers may verify that models are not only properly trained but are also seamlessly integrated with user-facing bundles and operational systems. Third, the experimentation involved in developing AI applications can also lead to redundant work. Developers may create multiple applications to determine whether a data pipeline, for example, is adequately configured for model prediction for particular scenarios, which may lead to the developers re-creating application bundles (e.g., model parameters, deployment environments, and/or application interfaces) when perhaps only slight adjustments are needed between experiments. Furthermore, changes to any bundle (e.g., model parameters, deployment environments, and/or application interfaces) may trigger cascading updates throughout the system, which can be error-prone and time-consuming.

These difficulties may be compounded by the technical barriers encountered when navigating the myriad tools and frameworks involved in AI application development and deployment. Data scientists may lack the DevOps skills used to deploy their models. For instance, data scientists may understand the services they want to use and how they want to use the services, but not how to call the services and integrate the services properly with other neighboring services. On the other hand, engineers familiar with DevOps (e.g., deployment frameworks) may not have the domain knowledge to optimize machine learning pipelines. For instance, DevOps engineers may understand how to call and integrate particular services, although they may not necessarily understand how to use the services to their full potential (e.g., to build a Random Forest with 500 trees, to build a RAG pipeline with a specific model, to save model weights). This dichotomy may slow development, increase costs, and limit the scalability of AI applications.

Due to the foregoing challenges, two options for the development of AI applications have emerged. With the first (or “manual”) approach, different teams of developers (e.g., data scientists and DevOps engineers) iteratively carry out different phases (e.g., the experimentation and deployment phases) of the AI application development process, often using different software tools. Maintaining or improving the performance of the AI application over time tends to involve coordinated attention by the data science team and the DevOps team. This approach tends to be very expensive and time-consuming. With the second (or “AI-controlled”) approach, a generative AI tool may be used to generate source code for an AI application. However, the source code generated by existing generative AI tools is often filled with semantic errors, such that producing even a passable prototype of the desired AI application may involve significant debugging of the source code, redevelopment of the application, and/or retraining of any models. The use of existing generative AI tools to generate commercial-grade AI software (in contrast to generating “toy” AI applications for personal use or educational experimentation) currently remains more in the realm of science fiction than industry practice.

Disclosed herein are application templates (or “templates”) for AI applications to address the foregoing challenges. An “application template” may include a pre-configured, modular framework that encapsulates the bundles, workflows, and/or configurations used for the development and/or deployment of an AI application on a software and/or infrastructure platform. A template may be designed to standardize and simplify the process of development and/or deployment of applications by integrating reusable bundles (e.g., components, libraries, toolkits, service bundles, and/or model packages) such as predefined logic, parameterized settings, and infrastructure requirements, while also accommodating customization for particular use cases.

An application template may include structured resources, such as predefined scripts, data structures, and model integrations, tailored to specific application domains (e.g., Q&A chatbots, predictive analytics tools, guarded RAG tools, etc.). Each template may abstract complex backend processes (e.g., developing generative AI models, implementing guardrails for input validation, managing data pipelines, etc.) into a cohesive, machine-executable workflow. The use of templates can enable users to rapidly deploy functional applications by focusing on application-specific customizations, such as uploading specific datasets or modifying user interface parameters, rather than reinventing core functionalities. Application templates can provide a highly functional starting point, reducing the technical expertise and time involved in development while enabling consistency and scalability across different applications built on the same platform (e.g., software and/or hardware stack).

In some embodiments, executing an application template includes generating a template instance that encodes a plurality of bundle specifications and dependency relationships among the bundles, deploying the bundles as separately managed entities that expose respective endpoints, and automatically configuring communication between deployed bundles by propagating endpoint identifiers and/or credential references into runtime configurations of dependent bundles. In some embodiments, each bundle may be implemented as one or more components, libraries, toolkits, service bundles, model artifacts, prompts, and/or connectors.

The templates may provide a unified framework that bridges the gap between data science and DevOps and streamlines the process of developing, deploying, and/or iterating on AI applications by encapsulating best practices, modular workflows, and/or automated orchestration. By integrating pre-configured yet customizable settings, the templates can reduce repetitive configuration tasks and potential errors. The templates may also enable seamless updates and customization, allowing teams to adapt their applications to evolving requirements without extensive reengineering. Furthermore, the templates may be structured into bundles, allowing developers to reuse code (e.g., for particular implementations and/or integrations) within and between applications. For example, a front-end developer can leverage an existing bundle to assemble a simple model (e.g., configured and trained with AutoML) for user-interface experimentation, and a data scientist can later replace that bundle with another bundle that includes a more sophisticated model. In this context, application templates represent a significant advancement, enabling organizations to accelerate the delivery of AI applications while maintaining quality and reliability. By simplifying development and reducing technical barriers to entry, templates enable greater accessibility and scalability for AI technologies.

### Some Examples of AI Development and Monitoring Systems

In some embodiments, systems and methods for the development, assessment, and/or monitoring of a generative AI (Gen AI) system include retrieval-augmented generation (RAG), combining a prompt construction facility, a knowledge base (KB), and a generative model. The KB organizes and represents information extracted from a corpus of source data, such as text, images, or videos. By including data outside the generative model’s training set, the KB bridges knowledge gaps, enhancing the system’s relevance. Information in the KB is structured using techniques such as vector embeddings, enabling efficient retrieval and augmentation of user queries.

When a user submits a query, the prompt construction facility integrates the input with context retrieved from the KB, forming an enriched prompt that is passed to the generative model. The model generates outputs, such as text or multimedia, tailored to the user’s needs. This retrieval-augmented approach enables the generative model to function as a natural language interface to the KB, leveraging external knowledge to improve accuracy and reduce hallucinations. Additionally, the system’s modular design allows updates to the KB or generative model independently, ensuring flexibility and cost efficiency.

Developing such systems may involve challenges, including optimizing KB creation, selecting appropriate embedding models, and addressing irrelevant data, missing data, or other issues. To streamline the development process, the system can, in some examples, use automated machine learning (AutoML) techniques to fine-tune hyperparameters, evaluate KB variations, and/or select optimal configurations. In some examples, time-filtering capabilities further refine the KB by restricting its data to specific date ranges, improving relevance to queries.

In some examples, the system incorporates advanced monitoring and moderation tools to maintain performance and integrity. Metrics, such as factual accuracy, latency, request rate, throughput, queue depth, execution resource (e.g., CPU, GPU, memory) utilization, token generation rate, and/or toxicity, may be tracked to identify drift, anomalies, and/or load characteristics. Guardrails, such as topicality and/or sentiment classifiers, may help prevent inappropriate use, while word impact analysis highlights key tokens in user queries, improving query refinement and KB curation. These features enable the system to remain robust and adaptive to changing inputs and requirements and to recommend or enact auto-scaling policies that increase or decrease provisioned execution resources in response to observed demand.

In practice, the Gen AI system supports diverse applications, such as chatbots, content generation, and language translation. By integrating monitoring, automated tuning, and/or user feedback, the system achieves continuous improvement with minimal disruption, enabling alignment with user expectations and domain-specific needs. In some embodiments, the system ensures that inference for predictive models and generative models remains responsive to load by dynamically adjusting replica counts, selecting batching strategies, performing adaptive rate limiting, and routing requests across heterogeneous hardware profiles to meet objectives such as latency and cost.

In some embodiments, an AI development system supports the creation, customization, and/or optimization of Gen AI systems. In some examples, the AI development system includes facilities for constructing and configuring system components and assessing their performance. Facilities can include a user interface facility for guiding system construction, a source data selection facility to curate information for the KB, and/or a KB development facility for processing source data into structured embeddings. The AI development system may also include a KB search development facility to configure retrieval mechanisms, a prompt construction facility for generating user-tailored inputs, and/or a generative model development facility for selecting and tuning the AI model. To streamline these processes, a hyperparameter tuning facility may automate parameter optimization for various system components.

In some embodiments, an operations facility manages the creation and lifecycle of cloud and edge execution resources and runtime configuration such that developers need not manually configure provider-specific deployment parameters. For example, the operations facility may accept developer-specified intent (e.g., target latency bands, concurrency limits, cost budgets, and hardware preferences such as CPU-only, GPU class, memory size, or accelerator type) and generate provider-specific settings for different environments, such as Amazon Web Services, Google Cloud Platform, OpenShift, and edge devices. The operations facility may recommend particular hardware profiles for a given workload and automatically provision, scale, and tear down execution resources based on observed metrics including request rate, system load, and latency. In some embodiments, the system maintains portability by expressing deployment configurations in an application template and resolving them at runtime (e.g., runtime configurations) to provider-native descriptors, thereby enabling consistent behavior across heterogeneous infrastructures while optimizing performance and utilization.

In some embodiments, an AI monitoring system that oversees the operation of generative AI systems. In some examples, the facilities of the AI monitoring system include a user interface facility for visualizing system performance and metrics, a qualitative assessment facility for analyzing topics and identifying outliers in the KB, and/or a quantitative assessment facility for evaluating system performance using synthetic evaluation data. A word impact facility may quantify the influence of specific words or phrases on system outputs, and/or an auditing facility may trace how KB embeddings contribute to generated content. Additionally, a prompt assessment facility may evaluate constructed prompts for cost, relevance, and/or drift.

In some embodiments, the AI development system generates a plurality of candidate Gen AI systems and/or candidate AI applications based on different respective templates and/or configuration values (e.g., different retrieval configurations, prompt templates, model identifiers, and/or hyperparameters). In some embodiments, the AI development system provides a plurality of queries to each candidate system, monitors one or more quantitative metrics (e.g., groundness scores, toxicity scores, cost estimates, latency, and/or accuracy), and provides comparative results and/or a recommendation regarding use or non-use of at least one candidate system.

In some embodiments, a word impact facility determines word impact scores for words in a query by constructing masked queries in which individual words are removed or masked, obtaining respective completions for the masked queries, and determining differences in one or more scoring metrics relative to a completion for the unmasked query. Word impact scores may be provided for display (e.g., as a heat map) and used to recommend revisions to a query, prompt, and/or corpus used by the KB, such as by identifying low-impact words and/or outlier embeddings.

Further embodiments of systems and methods for the development, assessment, and/or monitoring of generative AI applications are described in US 2025/0190459, which is incorporated by reference in its entirety.

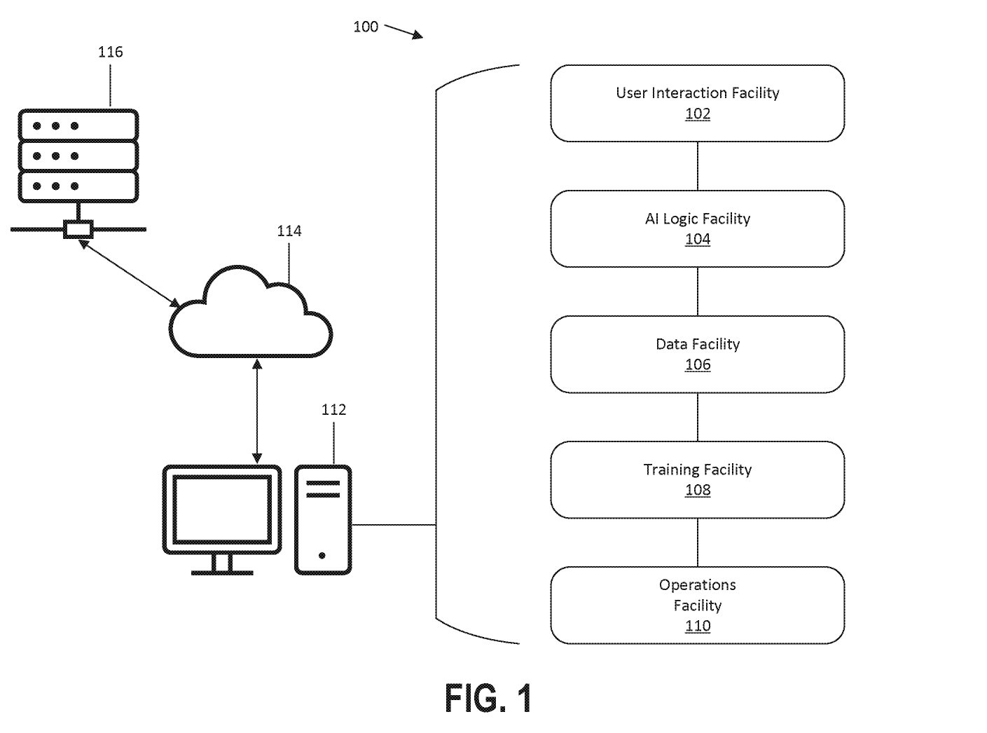

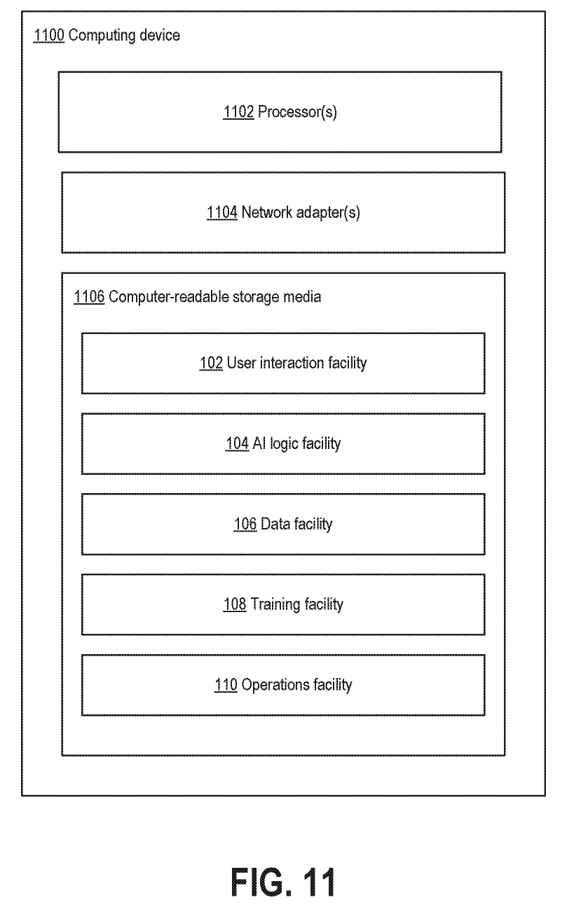

Referring now to the figures, wherein like numerals refer to the same or similar features in the various figures, FIG. 1 is a block diagram of a system 100, according to some embodiments. Not all of the depicted components may be used in all embodiments, and one or more embodiments may include additional, fewer, or different components than those shown in the figure. Variations in the arrangement and type of components may be made without departing from the spirit or scope of the present disclosure. Furthermore, the facilities described with respect to the system 100 are used for convenience to refer to functionality that a computing device 112 is configured to perform by way of one or more components of the computing device 112 (e.g., computer-readable instructions in non-transitory memory), which is described in detail below with respect to FIG. 11. Furthermore, in some examples, the computing device 112 is also configured to perform functionality described above with respect to the AI development system and/or AI monitoring system.

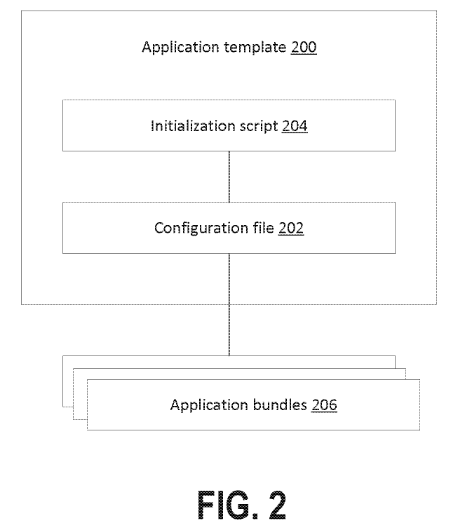

The computing device 112 may include an electronic device such as a laptop computer, desktop computer, tablet, smartphone, smartwatch, and/or any other electronic device, such as described in further detail below with respect to FIG. 11. The computing device 112 may be in electronic communication with other computing devices, such as a server 116, over a network 114, which may include a local area network (LAN), wide area network (WAN), virtual private network (VPN), internet, intranet, extranet, and/or the like. The computing device 112 may include one or more software applications, which may be used to access platforms, such as web applications, websites, API endpoints, and/or the like. The one or more software applications may include a package for initializing and/or updating an application template on the computing device 112 and/or one or more other electronic devices in network communication with the computing device 112 (e.g., the server 116), such as further described with respect to FIGS. 2-4.

The server 116 may include one or more electronic devices that provide access to resources, services, and/or data over the network 114 to one or more clients (e.g., computing device 112). The server 116 can include one or more physical and/or virtual electronic devices each including a processor, memory, and storage. The server 116 may also be configured to host websites and web applications, store data, manage network resources and security, run applications and services, and/or the like. In some embodiments, the server 116 is or includes a web server, database server, file server, cloud server, and/or the like.

As shown in FIG. 1, the system 100 may include one or more facilities for the development and/or deployment of an AI application. For example, the system 100 may include a user interaction facility 102, an AI logic facility 104, a data facility 106, a training facility 108, and an operations facility 110. Each facility of the system 100 may include software and/or hardware running on the computing device 112, the server 116, and/or any other electronic device implementing at least part of the system 100.

The user interaction facility 102 (e.g., a frontend) may provide a user interface between an end-user (e.g., user of the AI application) and underlying functionality of an AI application built using the techniques described herein. The facility 102 may facilitate interaction between end-users and underlying AI logic, including receiving user inputs (e.g., prompts, datasets, configuration selections, and/or feedback) and presenting outputs (e.g., visualizations, generated text, forecasts, and/or other results). In some embodiments, the user interaction facility 102 may be implemented using a web-based framework, such as Streamlit, to provide interactive dashboards and/or interfaces. For instance, in an AI forecasting application, the frontend may enable users to upload datasets, configure parameters such as prediction windows, and/or view forecast results in a visually rich format, such as graphs or tables. Similarly, in a content generation application, the frontend may provide a text input field for user prompts and display generated content alongside options for user feedback or refinement.

The user interaction facility 102 may be an intermediary that translates user inputs into AI inputs and/or pipeline invocations and translates AI outputs into user-facing responses. In some embodiments, this translation layer is configurable based on application logic, permissions, service tiers, and/or other requirements. For example, the user interaction facility 102 may route requests to different pipelines based on user context (e.g., selecting different models, different retrieval configurations, and/or different guardrails).

The AI logic facility 104 may perform operations such as processing inputs, executing AI pipelines, and generating outputs (e.g., via machine learning models). The facility 104 may bridge raw user inputs and/or external data with a particular application use case using machine learning models, natural language processing, predictive analytics, and/or other AI techniques. In some embodiments, facility 104 may include (or include connections to) a model inference engine, data processing facility, and output processing facility. The model inference engine may perform computations using trained model(s) (e.g., models obtained from and/or running on the server 116). The data processing facility may preprocess user-provided and/or system-generated inputs for compatibility with the model(s). The output processing facility may interpret and/or structure model results for downstream consumption (e.g., presentation via the user interaction facility 102).

In a guarded RAG application example, the AI logic facility 104 may use a vector database to retrieve context-relevant embeddings, provide retrieved context to a generative model (e.g., an LLM), and process the resulting outputs to provide accurate and contextually relevant completions and/or responses (e.g., the output processing facility).

In an AI forecasting application example, the AI logic facility 104 may preprocess time-series data, apply predictive analytics using trained models, and return insights such as forecasts and/or anomaly detections.

In a content generation application example, the AI logic facility 104 may integrate semantic search capabilities to retrieve relevant data and pair the retrieved data with an LLM to produce context based on a user query or instruction.

In some embodiments, for lightweight or edge-based applications, the AI logic facility 104 may use smaller, optimized models that can run efficiently on local devices (e.g., computing device 112) without requiring extensive computational resources. For large-scale applications or real-time performance, cloud-based AI services may be used to perform computational tasks remotely. In some embodiments, hybrid architectures may be employed, where certain elements of the AI logic, such as preprocessing or filtering, may be performed locally, while model inference may be handled remotely (e.g., on a cloud system) to balance latency and resource usage.

In some embodiments, the AI logic facility 104 supports multiple operational modes. In a customer-provided mode, users may supply custom-trained models, manually tuned hyperparameters, and manually configured training pipelines. In an automated mode (e.g., an AutoML mode), the AI logic facility 104 may assist with or control model discovery, training, and/or configuration, including hyperparameter tuning, model selection, and deployment. In an agentic mode, one or more generative AI agents may autonomously determine actions to take, tools to use, code to execute, and/or configurations to apply for one or more portions of an AI pipeline based on inputs, system state, contextual factors, and/or agent-specific goals. In some embodiments, an agent selects from a set of available tools exposed via an MCP server or tool registry, formulates tool invocation parameters, processes tool outputs, and determines subsequent actions based on the results. In some embodiments, multiple agents collaborate to complete a task, with each agent responsible for a portion of the workflow and communication managed by an orchestration layer.

The data facility 106 may include infrastructure (or connections to infrastructure) for managing, storing, and/or processing data utilized by AI and application logic. The facility 106 may facilitate access to operational and historical data, enabling models to generate predictions, insights, and/or other outputs, while supporting iterative improvement. In some embodiments, the data facility 106 includes a storage facility, data retrieval facility, and data integrity and accessibility facilities. The storage facility may include software and/or hardware for storing training and/or evaluation datasets. The data retrieval facilities may include software and/or hardware for obtaining data from one or more sources, such as remote repositories (e.g., hosted by the server 116). The data integrity and accessibility facilities may include software and/or hardware for performing data transformations, such as preprocessing pipelines that clean, normalize, and/or structure raw data (e.g., as vectors) before it is ingested by the model(s).

For example, in a forecasting application, the data facility 106 may include a structured database that stores historical time-series data, which may be accessed by a predictive model for scoring. In a content generation application, the data facility 106 may include a vector database that creates and/or stores document embeddings, allowing for RAG processes to enhance the quality of AI outputs by providing contextual information.

In some embodiments, for high performance and low latency applications, in-memory databases and/or distributed storage systems may be utilized. For applications handling large amounts of unstructured data, cloud storage services may be utilized. For applications where data privacy is a consideration, on-premises data management systems or private cloud storage solutions may be utilized.

The training facility 108 may enable modeling capabilities of an application, including predictive, inferential, and/or generative capabilities. In the training facility 108, a model development process may include data cleaning, feature engineering, model selection, prompt engineering, data augmentation, hyperparameter tuning, model fine-tuning, and/or model validation. In some embodiments, the resulting trained model may be evaluated for performance based on metrics such as accuracy, precision, recall, and/or objective functions (e.g., mean squared error) prior to deployment. In some embodiments, training data is sourced from historical datasets and/or real-time data streams. For example, in a time-series forecasting template, the training pipeline may process past observations to train a model capable of predicting future trends. In content generation templates, the training data may include large corpuses of text data to fine-tune a language model for domain-specific tasks. In some embodiments, the training facility 108 utilizes pre-trained model(s), including fine-tuning such model(s) for a particular domain.

In some embodiments, the training facility 108 supports iterative improvement of models based on feedback collected from users and/or system operations, such as corrections, ratings, and/or flagged output inaccuracies. Such feedback may be integrated into a training pipeline as additional data and/or annotations to existing datasets. For example, in RAG applications, feedback on irrelevant or inaccurate responses may be used to refine retrieval logic and/or improve the underlying vector database. In forecasting applications, discrepancies between predicted and actual outcomes may be used to retrain a model with updated data.

In some embodiments, the operations facility 110 integrates (e.g., via an API) with one or more machine learning operations (MLOps) platforms to monitor AI deployments. For example, in a guarded RAG application, the operations facility 110 may observe metrics such as response latency, model accuracy, and retrieval relevance. In forecasting and/or content generation applications, the operations facility 110 may track predictive model efficacy by analyzing output consistency and comparing predictions against outcomes. In some embodiments, alerts and logs generated by the operations facility 110 are used to identify anomalies, such as model drift and/or performance degradation.

In some embodiments, the capabilities of the operations facility 110 are dynamic and can be adjusted based on the selected modality of AI operation (e.g., custom configured, AutoML, or agentic flows). For custom configured models and/or code, the operations facility 110 may offer tracking and deployment management, allowing users to oversee versioning, hyperparameter adjustments, and integration with manually constructed training pipelines. In AutoML mode, the operations facility 110 may maintain oversight of ML metrics such as training time, accuracy, and computational efficiency to support real-time feedback loops and continuous retraining based on incoming data or performance changes (e.g., compared against benchmarks). For agentic flows, the operations facility 110 may observe agent behavior, tracking how agents dynamically generate and execute code, optimize AI pipelines, and make runtime adjustments based on evolving inputs. Monitoring in this mode may include logging agent decision pathways, evaluating the effectiveness of generated code, and confirming that automated actions align with predefined business logic and performance thresholds.

FIG. 2 is a block diagram of an example application template 200 including a configuration file 202 and an initialization script 204, according to one or more embodiments. The application template 200 is used to create and deploy an AI application using the system 100. The application template 200 may specify a set of (e.g., one or more) software bundles 206 configured to (e.g., selected for) a particular use case, such as guarded RAG, forecasting, and/or content generation. The set of software bundles 206 may act as scaffolding bundles that integrate facilities, settings, and workflows in discrete bundles to rapidly build and operate a scaffolded AI application with production-ready functionality for the particular use case. The set of software bundles 206 may also include predefined logic, modular logical components, and/or customizable parameters to deliver a ready-to-use application for users, reducing the complexity of traditional application development and deployment in which developers start from a blank project (e.g., file or directory).

The set of software bundles 206 may include complementary logic for AI requests (e.g., scoring and/or completion logic), application consumption (e.g., user interface logic and/or application business logic), and/or operations (e.g., infrastructure-as-code bundles and/or deployment configuration logic for serving and monitoring). In some embodiments, the set of software bundles 206 include one or more agent definitions, tool interfaces, prompt templates, MCP server configurations, and/or memory and/or context store configurations supporting an agentic application, such that bundles of an agentic workflow are instantiated, deployed, monitored, and/or updated as separate assets. In some embodiments, each bundle is associated with metadata including a version identifier, access control policies, deployment target, and/or monitoring configuration.

The configuration file 202 may control settings and aspects of the application, such as credentials, API keys, endpoints, model selections, deployment parameters, infrastructure settings, monitoring settings, and/or other parameters. In some embodiments, the configuration file 202 includes default values enabling an application to be initialized with reduced configuration effort, while also supporting customization. Default values may be pre-set configuration for bundles of the application such as models, deployment parameters, and infrastructure settings tailored to the particular use case of the application template 200.

In some embodiments, a user selects, via the configuration file 202, a subset of preconfigured application bundles (e.g., software bundles 206) from a library associated with the application template 200, and the resulting configuration produces a template instance for execution. In some embodiments, the initialization script 204 determines an ordered execution plan based on dependency relationships among the selected application bundles and deploys the selected application bundles as respective managed bundle objects and corresponding bundle endpoints. In some embodiments, the initialization script 204 automatically configures dependencies by injecting endpoint identifiers and/or credential references for upstream deployed bundles into runtime parameters, manifests, and/or environment variables used by downstream deployed bundles.

In some embodiments, a user initializes the application template 200 by providing an initialization command to the computing device 112, which may cause the computing device 112 to execute the initialization script 204. Execution of the initialization script 204 may orchestrate automated operations for creating and/or deploying an application based on the configuration file 202. Automated operations may include obtaining and/or integrating assets specified by the configuration file 202, including software bundles 206 such as data processing tools, models (e.g., pre-trained models), and application source code (e.g., libraries), and/or infrastructure components (e.g., virtual environments or runtime containers). In some embodiments, at least some assets are obtained from one or more other computing devices (e.g., server 116) and/or from one or more third-party services.

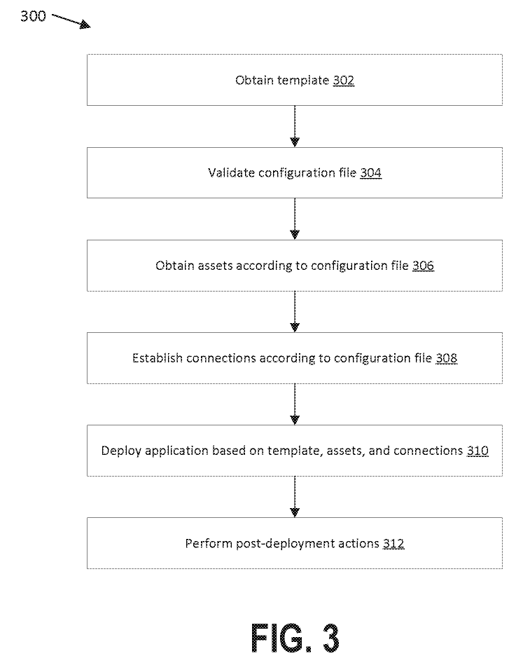

Automated operations may also include establishing connections with remote APIs, platforms, repositories, and/or other endpoints specified by the application template 200 and/or the configuration file 202. Establishing such connections may include connecting to resources such as data storage, authentication servers, model inference endpoints, and/or monitoring services. In some embodiments, the initialization script 204 performs automated deployment and setup of infrastructure such as virtual machines, storage solutions, and/or runtime environments. Once assets are obtained and connections are established, the application may be deployed to one or more deployment targets, such as described below with regard to FIG. 3.

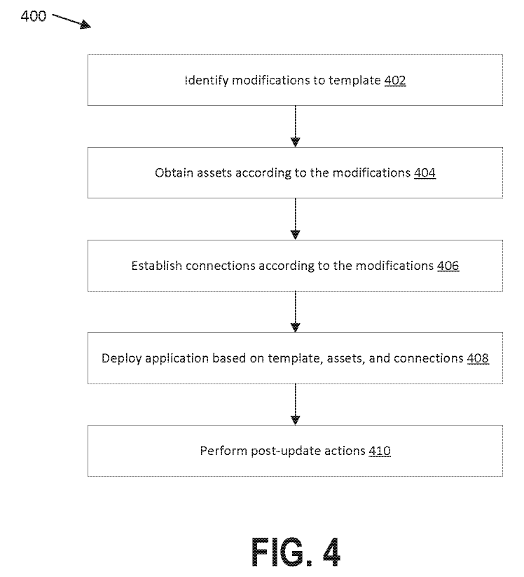

In some embodiments, the initialization script 204 is configured to support iterative deployment by enabling updates after an initial deployment. For example, after an application is operational, the initialization command may be executed again to apply changes to the application template 200 and/or the configuration file 202, such as further described below with regard to FIG. 4. In some embodiments, the initialization script 204 determines modifications to one or more software bundles 206 and selectively updates corresponding assets, connections, and/or deployed bundles, which can reduce downtime and computational overhead relative to redeploying the entire application.

FIG. 3 is a flow diagram illustrating an initial deployment process 300 (or “workflow”) executed using the initialization script 204, according to one or more embodiments. The process 300 may be performed by the computing device 112 responsive to receiving an initialization command associated with the application template 200. The process 300 is an example, and one or more operations of the process 300 may be performed in different orders, repeated, combined, and/or omitted, and additional operations may be performed.

In operation 302, the operations facility 110 obtains the application template 200. Obtaining the application template 200 may include obtaining the initialization script 204, configuration file 202, and/or the software bundles 206. The application template 200 may be obtained from a user computing device, where it may have been customized. The operations facility 110 may select a deployment target (e.g., the server 116 and/or other computing devices) based on the configuration file 202 of the template 200. The user interaction facility 102 may provide the application template 200 to a user for customization of the preconfigured use case associated with the application template 200.

In operation 304, the operations facility 110 parses the configuration file 202 and corresponding user configuration. The user configuration can select a subset of preconfigured application bundles and provide a set of configuration values for deployment. Application bundles may include modular, reusable software components and may be preconfigured with logic, settings, and/or runtime variables (e.g., dependencies and defaults) that can be deployed with minimal additional setup. The operations facility 110 may verify availability of referenced assets, parameters, and/or endpoints; verify credentials and permissions; and/or verify compatibility among the selected bundles (e.g., model identifiers, runtime versions, and infrastructure selections).

The operations facility 110 may generate environment-specific artifacts based on the configuration file 202, such as deployment manifests, environment variable files, and/or parameter sets for infrastructure-as-code specifications. The operations facility 110 may then generate, based on the application template 200 (e.g., configuration values), a template instance that identifies the selected bundles and their dependency relationships, and determine an ordered execution plan by evaluating a dependency graph for the selected bundles. The dependency graph may be generated according to the selected preconfigured bundles and their declared inputs, outputs, and dependency metadata, instantiating a node for each bundle. Directed edges may be added to the graph and from each dependent bundle to its upstream requirements, and the resulting graph is validated and topologically ordered to determine the provisioning and deployment sequence. The execution plan may be used to order provisioning and deployment actions for the subset of application bundles.

In operation 306, the data facility 106 obtains one or more first assets according to the configuration file 202. The one or more first assets may include data processing tools, models (e.g., pre-trained models), vector databases and/or vector database configurations, training data, training pipelines, application source code (e.g., libraries), user interface resources, and/or infrastructure components (e.g., runtime containers and/or virtual environments). The first assets may include at least some of the software bundles 206. In some embodiments, the data facility 106 obtains at least some of the first assets from one or more remote computing devices (e.g., server 116), from one or more third-party services, and/or from one or more storage repositories.

In operation 308, the operations facility 110 establishes one or more connections with one or more remote computing devices according to the configuration file 202. These connections may include data storage services, authentication services, model inference endpoints, monitoring services, and/or deployment platforms. Establishing the connections may include provisioning infrastructure resources (e.g., compute instances, container clusters, and/or storage volumes) and configuring access policies, secrets, and/or credentials for deployment and runtime operation. When the configuration file 202 identifies an external data source, the operations facility 110 may establish a credentialed connection to that external data source and persist credential references for use by managed bundle objects during runtime.

In operation 310, the operations facility 110 deploys, onto one or more second computing devices, an application based on the application template 200, the one or more assets, and the one or more connections. Deployment may include packaging application bundles, building and/or retrieving container images, configuring runtime parameters, deploying services and/or workflows to a deployment platform, and exposing one or more application endpoints for user interaction. For the selected subset of application bundles, the operations facility 110 may create a respective managed bundle object that includes executable logic and runtime configuration, and deploy each managed bundle object as a corresponding bundle endpoint on provisioned execution resources in a deployment environment. Runtime configuration may include the environment-specific parameters provided to a deployed bundle at execution time. These parameters may include environment variables, endpoint identifiers, credentials, resource limits, and feature flags and may control how the bundle is instantiated, connects to dependencies, and behaves in the deployment environment.

The operations facility 110 may configure communication between bundle endpoints by updating a downstream runtime configuration with an identifier of an upstream bundle endpoint from which output is obtained as input. In some implementations, the selected bundles include at least an inference bundle and an interface bundle, and the exposed application endpoint receives a request and routes the request through a sequence of bundle endpoints according to an execution graph derived from the template instance. One or more bundle endpoints may be invoked to generate a response, and the operations platform may present bundle-specific metrics for at least some managed bundle objects.

In some embodiments, deploying the application based on the application template 200 includes allocating computing resources in a deployment environment for the software bundles 206 associated with the configuration file 202 and linking the software bundles 206 together to enable the software bundles 206 to communicate with each other. For example, the computing device 112 may cause a second computing device to allocate computational resources, connect with a remote API for specialized data, deploy a set of containerized processes onto the computational resources, and link corresponding containerized processes together to establish input/output dependencies according to the configuration file 202 and with a single execution of the initialization script 204.

In some embodiments, deploying the application based on the application template 200 includes generating an execution graph. An execution graph includes a directed representation of the bundle endpoints and invocation paths derived from the application template and/or its dependency graph by resolving selected bundles into deployed endpoints and ordering their operations for request servicing. The execution graph may be generated by mapping dependency relationships into executable routes, expanding nodes to endpoint identifiers, and arranging the operation sequence and branching paths. An application endpoint may be configured with routing logic that consults the execution graph to select and invoke bundle endpoints in the prescribed order, passing intermediate outputs as inputs downstream. Using runtime configuration (e.g., endpoint identifiers, credentials, and feature flags), the application endpoint facilitates connections between endpoints, handles branching and errors between endpoints according to the execution graph, and returns the final response.

In operation 312, the operations facility 110 performs one or more post-deployment actions. Post-deployment actions include performing health checks, generating logs and/or status outputs for the user interaction facility 102, and/or storing a deployment state associated with the deployed application for use in subsequent executions of the initialization command (e.g., in the update handling workflow of FIG. 4). In some embodiments, the deployment state includes, for each deployed bundle, a bundle identifier, bundle type, version identifier, endpoint identifier, and dependency references, enabling subsequent dependency-based selective updates to the application.

FIG. 4 is a flow diagram of an update handling process 400 (or “workflow”) executed using the initialization script 204, according to one or more embodiments. The process 400 may be performed by the computing device 112 responsive to receiving the initialization command after an initial deployment (e.g., after performing the process 300 of FIG. 3). The process 400 is an example, and one or more operations of the process 400 may be performed in different orders, repeated, combined, and/or omitted, and additional operations may be performed.

In operation 402, the operations facility 110 identifies modifications to the application template 200. The application template 200 may be obtained from a user computing device or application repository. The operations facility 110 may identify the modifications by comparing a current version of the application template 200 against a deployment state associated with a previous deployment of the application (e.g., a deployment state stored at operation 312). The modifications may include a modification, supplementation, and/or removal of at least part of the application template 200, such as the configuration file 202. In some embodiments, the modifications include changes to model selections, training parameters, data processing workflows, user interface bundles, deployment parameters, and/or monitoring settings.

In some embodiments, operation 402 includes determining an impact of the modifications on the deployed application. The operations facility 110 may compare a modified managed bundle object against the stored deployment state and dependency relationships to determine which assets, connections, and/or deployed bundles are affected and which remain unaffected. In some embodiments, the operations facility 110 uses a dependency graph, file manifests, and metadata (e.g., checksums, version identifiers, timestamps, and declared dependencies) to determine impacted bundles, including downstream dependent managed bundle objects. Based on the impact set, operation 402 may generate an updated ordered execution plan for redeploying modified bundles and associated downstream dependent bundles.

In operation 404, the data facility 106 obtains one or more second assets according to the identified modifications. The second assets may include a model, vector database, training data, training pipeline, and/or other assets such as application source code, configuration artifacts, container images, and/or infrastructure components. In some embodiments, the data facility 106 obtains at least some of the second assets from one or more remote computing devices (e.g., server 116), from one or more third-party services, and/or from one or more storage repositories. In some embodiments, operation 404 includes obtaining updated assets while retaining previously obtained assets that are not affected by the one or more modifications. In some embodiments, operation 404 includes verifying integrity indicators (e.g., checksums and/or signatures) associated with the obtained assets.

In operation 406, the operations facility 110 establishes one or more second connections with one or more remote computing devices according to the modifications. In some embodiments, the one or more second connections include connections to data storage services, authentication services, model inference endpoints, monitoring services, and/or deployment platforms. In some embodiments, establishing the one or more second connections includes establishing new connections, modifying existing connections, rotating credentials, and/or provisioning additional infrastructure resources. In some embodiments, the operations facility 110 retains one or more existing connections that are not affected by the one or more modifications.

In operation 408, the operations facility 110 deploys, onto one or more second computing devices, the application based on the application template 200, the one or more second assets, and/or the one or more second connections. Rather than redeploying the entire application, operation 408 may selectively redeploy a modified managed bundle object and one or more dependent managed bundle objects while leaving unaffected bundles in place. The operations facility 110 may update runtime configurations of downstream deployed bundles by propagating updated endpoint identifiers and/or credential references associated with redeployed bundles, while preserving runtime configurations for unaffected bundles. For example, if a modification affects model behavior, the operations facility 110 may update model-related bundles while retaining user interface bundles and data pipelines that are unaffected. In some embodiments, the selective redeployment is performed as a replacement of a deployed version of the modified managed bundle object with an updated deployed version, such as through a rolling update or continuous integration / continuous deployment sequence, while maintaining availability of the application endpoint and storing version information to support rollback.

In operation 410, the operations facility 110 performs one or more post-update actions. In some embodiments, post-update actions include performing health checks, monitoring one or more metrics for performance degradation and/or drift, generating logs and/or status outputs for the user interaction facility 102, and/or updating the deployment state for use in subsequent executions of the initialization command.

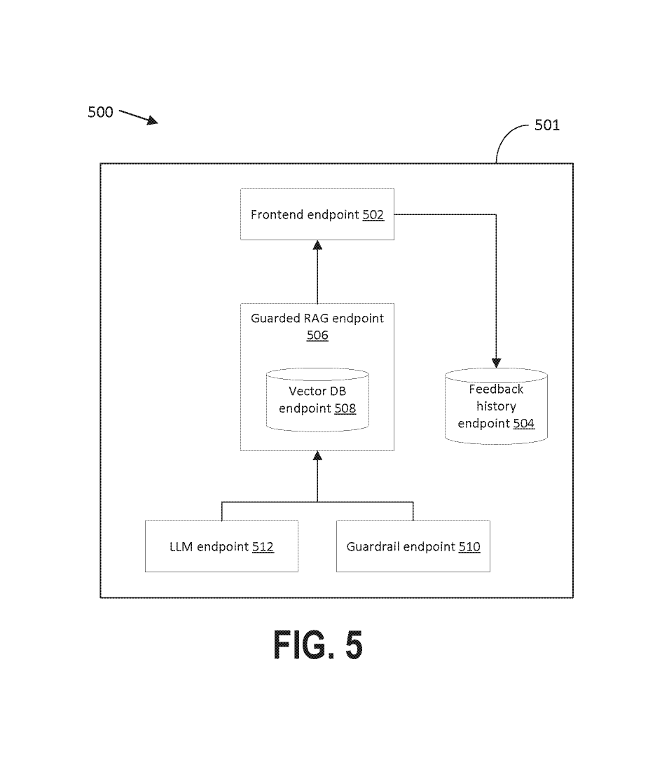

FIG. 5 is a block diagram of an example RAG application architecture 500, according to one or more embodiments. In some embodiments, the RAG application architecture 500 is generated, deployed, and/or updated using the application template 200 and the initialization workflows described with regard to FIGS. 2-4. In some embodiments, the RAG application architecture 500 provides a hosted and shareable user interface, business logic, and guardrails for servicing user requests, a predictive secondary model for evaluating response quality, and custom metrics for monitoring performance. The RAG application architecture 500 may be hosted on a computing environment 501, which may be an embodiment of the server 116 and/or computing device 1100 with execution (e.g., computational) resources available for provisioning to the various bundles of the architecture.

The RAG application architecture 500 may include software bundles such as a user interface 502, a guarded RAG endpoint 506, a vector database endpoint 508, a feedback history endpoint 504, one or more guardrail endpoints 510, and/or a generative AI model 512 (e.g., an LLM endpoint). The user interface 502 may be implemented as part of the user interaction facility 102 (e.g., as a web application frontend). The guarded RAG endpoint 506 may be implemented as part of the AI logic facility 104, the vector database endpoint 508 and the feedback history endpoint 504 may be implemented as part of the data facility 106, and the one or more guardrail endpoints 510 and the deployment of the generative model 512 may be implemented as part of the training facility 108 and/or the operations facility 110, depending on the embodiment. In some embodiments, one or more of the deployments of FIG. 5 are monitored and/or governed using an operations platform, such as an MLOps platform.

The RAG application architecture 500 may be instantiated using one or more setup processes performed responsive to executing the initialization script 204. For example, a grounding data setup may include obtaining input documents, generating document chunks, generating vector embeddings, and/or creating and/or updating the vector database endpoint 508. An LLM setup may include provisioning and/or configuring the generative model 512. A predictive guard model setup may include generating deployment assets, training and/or selecting one or more guard and/or grading models, and deploying such models as one or more of the guardrail endpoints 510. An application deployment setup may include generating application assets and configuring an application execution environment (e.g., a container runtime and/or other runtime environment) and corresponding versions. A monitoring and/or real-time intervention setup may include configuring one or more custom metrics dashboards, alerts, and/or logging within the operations platform.

The RAG application architecture 500 may be preconfigured to use grounding data as context for generative model outputs. For example, input data (e.g., documents, web pages, and/or other data) may be transformed into document chunks and vector embeddings, which may be stored in the vector database endpoint 508. In some embodiments, the vector database endpoint 508 is updated as new grounding data is added, removed, and/or modified, such as by rebuilding embeddings and/or selectively updating embeddings associated with changed source documents.

The one or more guardrail endpoints 510 may include predictive models and/or LLM-based classifiers. The one or more guardrail endpoints 510 may be preconfigured to perform compliance and safety checks for inputs and/or outputs of the guarded RAG endpoint 506. For example, the one or more guardrail endpoints 510 may include a guard model configured to classify prompts and/or responses as allowed or disallowed, and/or a grading model configured to score the quality of one or more responses (e.g., groundedness, topicality, and/or other quality indicators). In some embodiments, the guarded RAG endpoint 506 uses the outputs of the one or more guardrail endpoints 510 to select between different response strategies (e.g., refusing a request, requesting clarification, selecting a different prompt template, and/or returning a response with citations and/or retrieved context).

In some embodiments, the operations platform collects and/or computes one or more custom metrics for the RAG application architecture 500. For example, the one or more custom metrics may include completion token counts, groundedness scores, estimated LLM cost, prompt refusal rates, response latency, and/or retrieval relevance. In some embodiments, the operations platform provides monitoring dashboards, alerts, and/or logging that support tracing requests through the user interface 502, the guarded RAG endpoint 506, the vector database endpoint 508, the one or more guardrail endpoints 510, and the generative model 512.

In operation, the user interface 502 may receive, from a user, a query and/or other input, and may send a corresponding request to the guarded RAG endpoint 506. In some embodiments, the guarded RAG endpoint 506 invokes the one or more guardrail endpoints 510 to evaluate the user input prior to performing retrieval. In some embodiments, the guarded RAG endpoint 506 queries the vector database endpoint 508 to retrieve context relevant to the user input and constructs a prompt based on the user input and the retrieved context. The guarded RAG endpoint 506 may provide the prompt to the generative model 512 to obtain a completion and may post-process the completion using the one or more guardrail endpoints 510 and/or other business logic. The user interface 502 may provide the response to the user and may receive feedback regarding response quality. In some embodiments, feedback and/or interaction data is stored in the feedback history endpoint 504 and used to improve the RAG application architecture 500 over time (e.g., by updating grounding data, refining retrieval logic, and/or training and/or updating one or more guardrail endpoints 510).

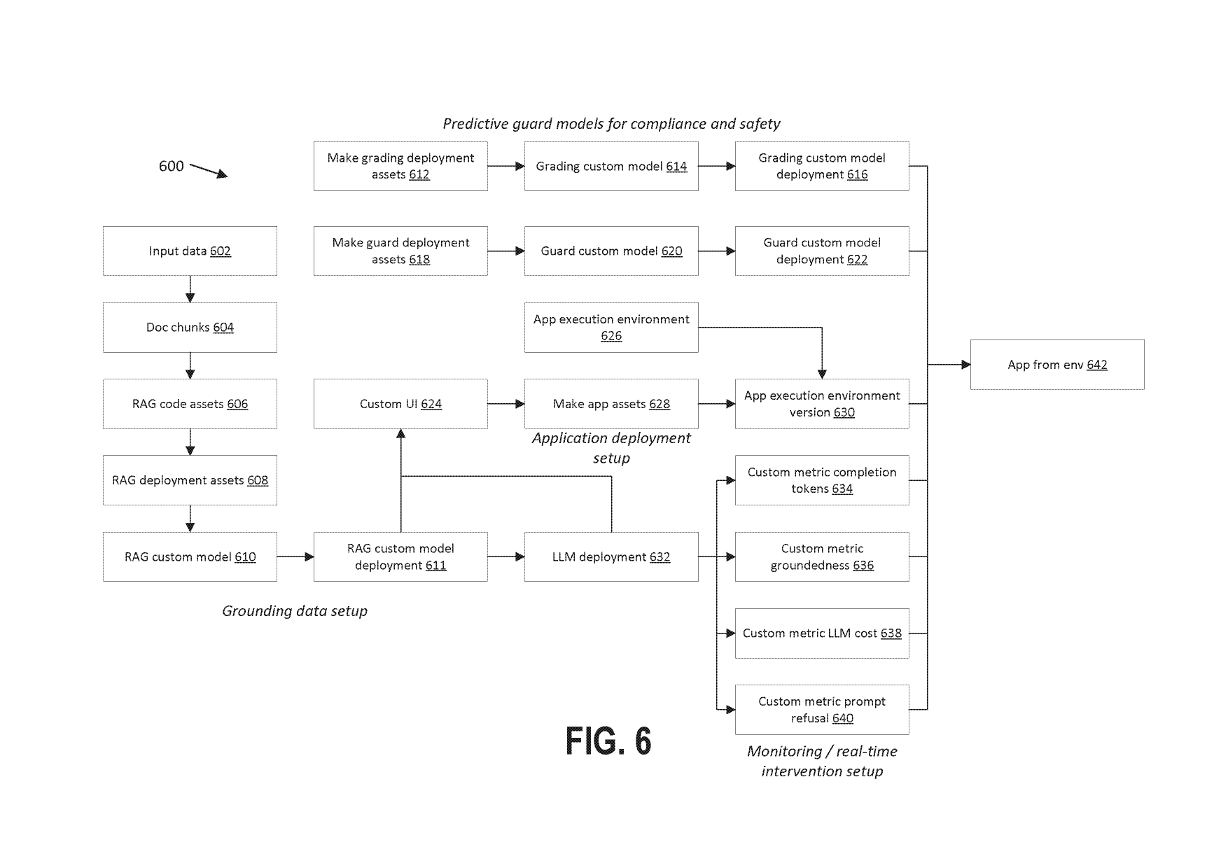

FIG. 6 is a dependency graph based on the guarded RAG architecture 500, according to one or more embodiments. As illustrated, the graph 600 may be executed (at least in part) responsive to execution of the initialization script 204 and may include a grounding data setup phase, a predictive guard models for compliance and safety phase, an application deployment setup phase, and a monitoring / real-time intervention setup phase.

In the grounding data setup phase, input data 602 is transformed into document chunks 604, which are used to generate RAG code assets 606 and RAG deployment assets 608, and to generate and/or update a RAG custom model 610 that is deployed as a RAG custom model deployment 611. In some embodiments, the RAG custom model deployment 611 is configured to perform retrieval against a vector database (e.g., vector database endpoint 508 of FIG. 5) and to cooperate with an LLM deployment 632 (e.g., implementing generative model 512 of FIG. 5) to provide RAG responses.

In the predictive guard models for compliance and safety phase, grading deployment assets 612 are generated to produce a grading custom model 614 and a grading custom model deployment 616, and guard deployment assets 618 are generated to produce a guard custom model 620 and a guard custom model deployment 622. In some embodiments, the deployments 616 and 622 correspond to and/or are invoked as one or more guardrail endpoints 510 of FIG. 5.

In the application deployment setup phase, a custom user interface 624 (e.g., implementing user interface 502 of FIG. 5) and one or more application assets generated at 628 are combined with an app execution environment 626 to produce an app execution environment version 630 that is configured to invoke the RAG custom model deployment 611, the LLM deployment 632, and/or the predictive guard deployments 616 and 622. In some embodiments, the configuration of the app execution environment version 630 includes runtime parameters into which endpoint identifiers for deployments 611, 616, 622, and 632 are injected to establish dependency-correct communication.

In the monitoring / real-time intervention setup phase, one or more custom metrics are configured and/or emitted, including completion tokens 634, groundedness 636, LLM cost 638, and prompt refusal 640, which may be monitored by an operations platform of FIG. 5 to support alerts and/or runtime governance. The app execution environment version 630 may then be used to deploy and/or update an application instance 642 (“app from env”) that exposes the custom user interface 624 and services user requests using the deployed bundles.

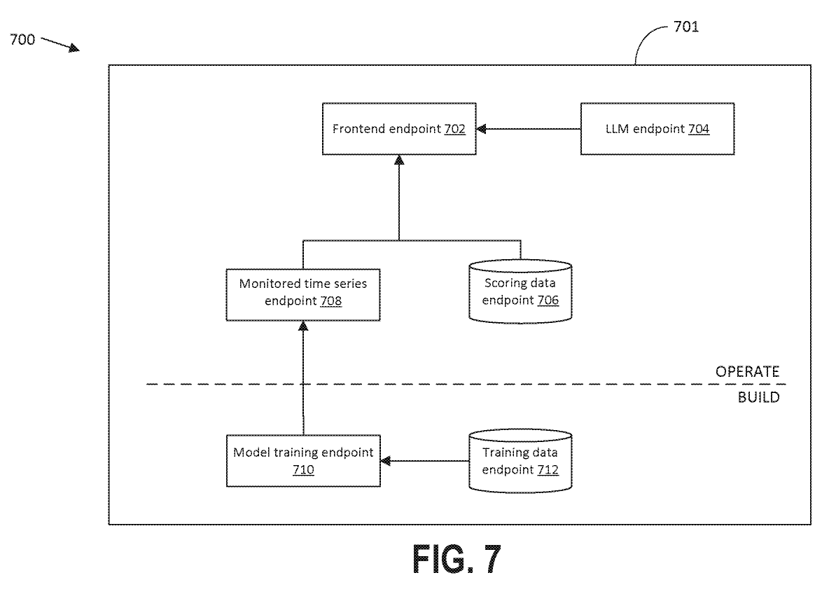

FIG. 7 is a block diagram of a forecasting application architecture 700, according to one or more embodiments. In some embodiments, the forecasting application architecture 700 is generated, deployed, and/or updated using the application template 200 and the initialization workflows described with regard to FIGS. 2-4. The forecasting application architecture 700 provides a hosted and shareable user interface, predictive model training and deployment for time-series forecasting, and natural language explanations of factors driving forecast for a selected series at a selected time. The forecasting application architecture 700 may be hosted on a computing environment 701, which may be an embodiment of the server 116 and/or computing device 1100 with execution (e.g., computational) resources available for provisioning to the various bundles of the architecture.

In some embodiments, the forecasting application architecture 700 includes software bundles such as a user interface 702, a generative model endpoint 704 (e.g., an LLM deployment), a scoring data endpoint 706, a monitored time series endpoint 708, a model training endpoint 710, and a training data endpoint 712. The user interface 702 may be implemented as part of the user interaction facility 102 of FIG. 1 (e.g., as a web application frontend). The monitored time series endpoint 708 and the model training endpoint 710 may be implemented as part of the AI logic facility 104 and/or the training facility 108. The scoring data endpoint 706 and the training data endpoint 712 may be implemented as part of the data facility 106. The generative model endpoint 704 and the monitored time series endpoint 708 may be monitored and governed using an operations platform (e.g., an MLOps platform) as part of the operations facility 110.

In some embodiments, the forecasting application architecture 700 includes a “build” phase and an “operate” phase. During the build phase, the model training endpoint 710 may obtain training data from the training data endpoint 712, perform data preparation (e.g., cleaning, normalization, feature engineering, and/or time-series transformations), and train one or more predictive models for time-series forecasting. In some embodiments, the model training endpoint 710 includes selecting a model type, selecting features and/or lags, selecting a forecast horizon, performing hyperparameter tuning, evaluating one or more candidate models, and selecting a trained model for deployment. The selected model may be deployed as the monitored time series endpoint 708.

In some embodiments, the scoring data endpoint 706 stores scoring data used to generate forecasts in the operate phase. The scoring data may include, for example, one or more time-series, associated timestamps, exogenous variables, covariates, known future inputs, and/or other data used by the monitored time series endpoint 708 to generate forecast values. In some embodiments, scoring data is generated and/or updated using a scoring data preparation workflow (e.g., a notebook-driven workflow) and stored for access by the user interface 702 and/or the monitored time series endpoint 708. In some embodiments, a scoring data preparation workflow is executed on a schedule to keep scoring data current.

During the operate phase, the user interface 702 may receive, from a user, one or more selections identifying a time-series and a time interval (and/or other parameters) for forecasting. The user interface 702 may obtain corresponding scoring data from the scoring data endpoint 706 and provide at least a portion of the scoring data to the monitored time series endpoint 708 to obtain a forecast. The user interface 702 may present forecast outputs in one or more visualizations (e.g., charts and/or tables) and may also present explanations regarding drivers of the forecast.

In some embodiments, the user interface 702 obtains explanations by invoking the generative model endpoint 704 using prompts that include forecasting outputs and/or metadata associated with the monitored time series endpoint 708. For example, the prompts may include a selected series identifier, a selected time, a forecast horizon, confidence intervals, feature importance values, anomaly indicators, and/or other explanatory signals. The generative model endpoint 704 may generate natural-language explanations of factors driving the forecast, which may be tailored for a particular series at a particular time.

In some embodiments, the operations platform collects and/or computes operational metrics for the forecasting application architecture 700. Such metrics may include prediction latency, throughput, error rates, and/or data drift indicators. In some embodiments, the operations platform supports monitoring of forecast quality by comparing predicted outcomes against actual outcomes when available and generating alerts when performance degrades. In some embodiments, degradation and/or drift may trigger retraining of the predictive model via the model training endpoint 710 and redeployment of an updated time series model as the monitored time series endpoint 708.

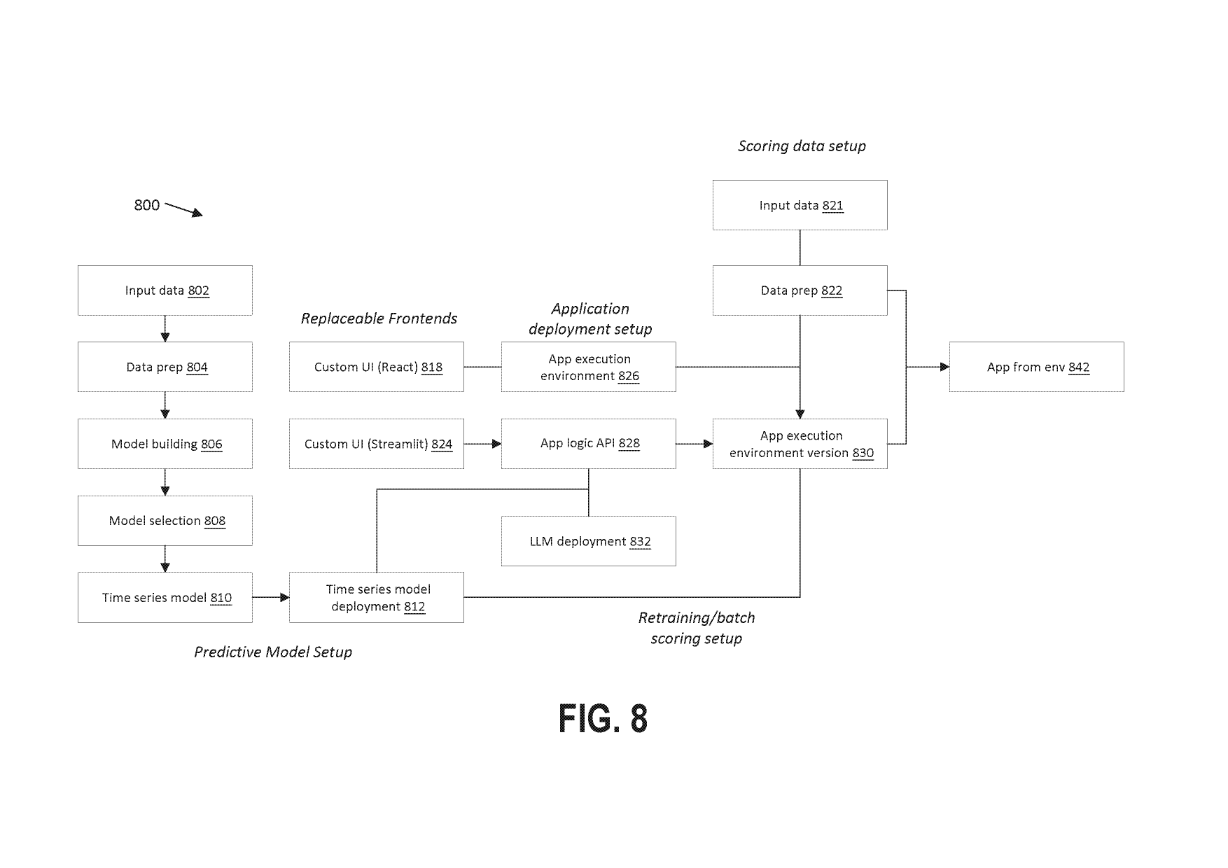

FIG. 8 is dependency graph based on the forecasting application architecture 700, according to one or more embodiments. As illustrated, the graph 800 may be executed (at least in part) responsive to execution of the initialization script 204 and may include a predictive model setup phase, a frontend phase, an application deployment setup phase, a scoring data setup phase, and a retraining/batch scoring setup phase.

In the predictive model setup phase, input data 802 is processed via data preparation 804 and used for model building 806 and model selection 808 to produce a time series model 810 that is deployed as a time series model deployment 812. In some embodiments, the time series model deployment 812 implements the monitored time series endpoint 708 of FIG. 7.

In the scoring data setup phase, input data 821 is processed via data preparation 822 to generate and/or update scoring data used by the deployed application (e.g., scoring data stored in scoring data endpoint 706 of FIG. 7).

In the replaceable frontends phase, one or more user interface implementations may be provided, including a custom web UI 818 and/or a custom dashboard UI 824. Such user interfaces may implement user interface 702 of FIG. 7 and may interact with the deployed bundles via an application programming interface such as app logic API 828.

In the application deployment setup phase, an app execution environment 826 is provisioned and used to generate and/or deploy application bundles (e.g., the app logic API 828) and to generate an app execution environment version 830 that defines a versioned deployment configuration for the application. In some embodiments, the app execution environment version 830 is configured to invoke the time series model deployment 812 to obtain forecasts and to invoke an LLM deployment 832 (e.g., implementing the generative model endpoint 704 of FIG. 7) to generate explanations based on forecasting outputs and/or metadata. In some embodiments, endpoint identifiers associated with the time series model deployment 812 and the LLM deployment 832 are propagated into runtime configuration used by the app logic API 828 and/or the selected frontend (e.g., 818 or 824).

In the retraining/batch scoring setup phase, the app execution environment version 830 may be configured to support scheduled scoring, retraining, and/or redeployment of an updated time series model as the time series model deployment 812 based on updated training and/or scoring data. The app execution environment version 830 may then be used to deploy and/or update an application instance 842 (“app from env”) that exposes one or more of the custom user interfaces 818 and 824 and services user requests using the deployed bundles.

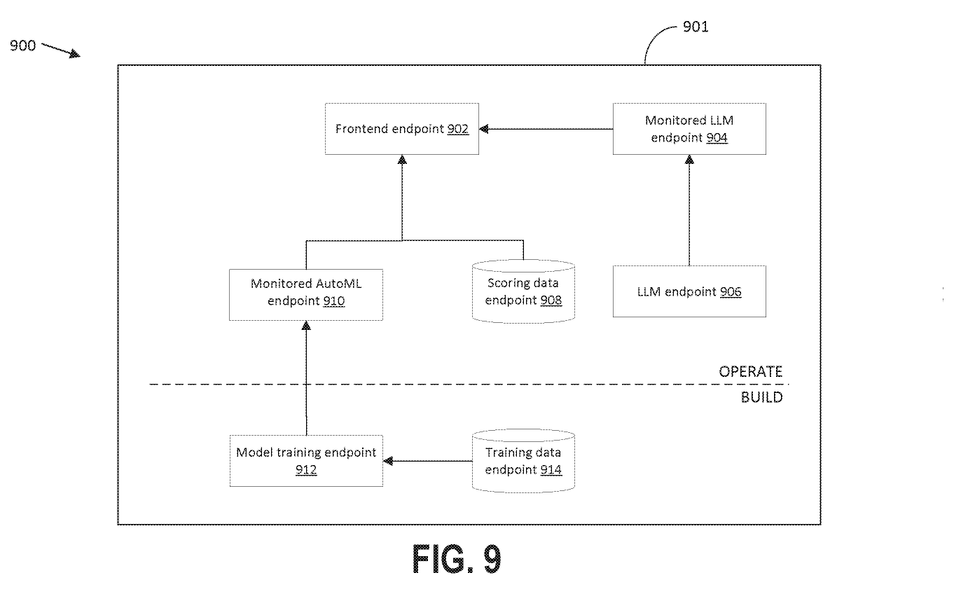

FIG. 9 is a block diagram of a content generation application architecture 900, according to one or more embodiments. In some embodiments, the content generation application architecture 900 is generated, deployed, and/or updated using the application template 200 and the initialization workflows described with respect to FIGS. 2-4. The content generation application architecture 900 may generate content using predictive model outputs and a generative model, and may provide a shareable user interface for interacting with predictive/generative bundles. The content generation application architecture 900 may be hosted on a computing environment 901, which may be an embodiment of the server 116 and/or computing device 1100 with execution (e.g., computational) resources available for provisioning to the various bundles of the architecture.

The content generation application architecture 900 may include software bundles such as a user interface 902, a monitored LLM endpoint 904, an LLM endpoint 906, a scoring data endpoint 908, a monitored AutoML endpoint 910, a model training endpoint 912, and/or a training data endpoint 914. The user interface 902 may be implemented as part of the user interaction facility 102 of FIG. 1 (e.g., as a web application frontend). The monitored AutoML endpoint 910 and the model training endpoint 912 may be implemented as part of the AI logic facility 104 and/or the training facility 108. The scoring data endpoint 908 and the training data endpoint 914 may be implemented as part of the data facility 106. In some embodiments, the monitored AutoML endpoint 910 and the monitored LLM endpoint 904 are monitored and governed by one or more operations facilities (e.g., operations facility 110), including tracking deployment health, usage, and/or performance metrics.

In some embodiments, the content generation application architecture 900 includes a “build” phase and an “operate” phase. During the build phase, the model training endpoint 912 may obtain training data from the training data endpoint 914, perform data preparation, and train one or more predictive models (e.g., classification models and/or regression models) using automated machine learning (AutoML) and/or other modeling techniques. In some embodiments, the model training endpoint 912 evaluates multiple candidate models and selects a trained model for deployment as the monitored AutoML endpoint 910. In some embodiments, the monitored LLM endpoint 904 is also provisioned and/or configured during the build phase, including selecting an underlying LLM endpoint 906 and configuring prompt templates, content policies, and/or other runtime parameters.

In some embodiments, the scoring data endpoint 908 stores scoring data used during the operate phase. The scoring data may include, for example, feature records to be scored, user-provided inputs, policy constraints, and/or other context used to generate content. In some embodiments, scoring data is generated and/or updated using a scoring data preparation workflow and stored for access by the user interface 902 and/or one or more deployments.

During the operate phase, the user interface 902 may receive, from a user, one or more content generation requests and/or one or more inputs associated with a particular use case. In some embodiments, a request corresponds to generating personalized promotional content using a next-best-offer model, generating approval and/or rejection letters using a risk model, generating summaries, generating customer support responses, and/or other content that is informed by predictive model outputs. The user interface 902 may obtain scoring data from the scoring data endpoint 908 and provide at least a portion of the scoring data to the monitored AutoML endpoint 910 to obtain one or more predictive outputs (e.g., class labels, probabilities, scores, and/or recommended actions).

In some embodiments, the user interface 902 and/or the monitored LLM endpoint 904 constructs a prompt that includes at least a portion of the scoring data and the predictive outputs and provides the prompt to the LLM endpoint 906 to obtain generated content. In some embodiments, the monitored LLM endpoint 904 performs post-processing of LLM outputs, such as applying formatting rules, applying content policies, performing compliance and/or safety checks, and/or selecting between alternative prompt templates based on the predictive outputs and/or user context. The user interface 902 may present generated content to the user and may receive feedback and/or edits, which may be stored and used to improve future generations (e.g., by updating prompt templates, updating content policies, and/or retraining the predictive model via the model training endpoint 912).

In some embodiments, the content generation application architecture 900 is instantiated using one or more setup families performed responsive to executing the initialization script 204. For example, a predictive model setup may include ingesting input data, performing data preparation, training and selecting a predictive model, and deploying the predictive model as the monitored AutoML endpoint 910. An LLM setup may include deploying and/or configuring the monitored LLM endpoint 904 and selecting the LLM endpoint 906. An application deployment setup may include generating application assets and configuring an application execution environment and corresponding versions for hosting the user interface 902 and associated business logic. A monitoring and/or real-time intervention setup may include configuring one or more custom metrics, dashboards, alerts, and/or logging for the monitored AutoML endpoint 910 and the monitored LLM endpoint 904.

In some embodiments, monitoring includes collecting and/or computing metrics for evaluating generated content and system performance. For example, one or more metrics may include completion token counts, readability scores, estimated LLM cost, sentiment analysis results, refusal rates, and/or latency. In some embodiments, monitoring and/or user feedback supports iterative refinement of the predictive model, the generative model prompts, and/or other bundles of the content generation application architecture 900.

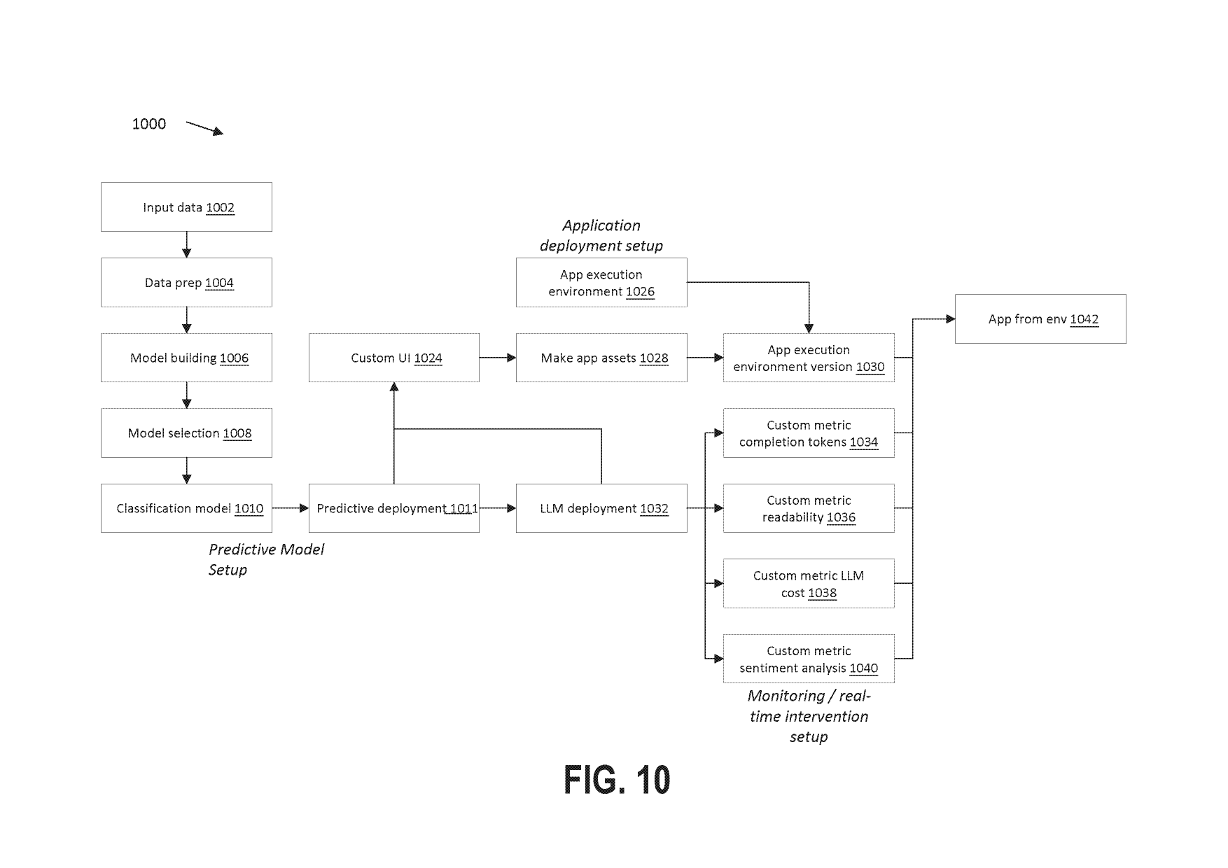

FIG. 10 is a dependency graph based on the architecture of FIG. 9, according to one or more embodiments. As illustrated, the graph 1000 may be executed (at least in part) responsive to execution of the initialization script 204 and may include a predictive model setup phase, an application deployment setup phase, and a monitoring / real-time intervention setup phase.

In the predictive model setup phase, input data 1002 is processed via data preparation 1004 and used for model building 1006 and model selection 1008 to produce a classification model 1010 that is deployed as a predictive deployment 1011. In some embodiments, the predictive deployment 1011 implements the monitored AutoML endpoint 910 of FIG. 9. In some embodiments, the predictive deployment 1011 generates one or more predictive outputs used for controlling and/or conditioning content generation, and provides at least a portion of such outputs to a user interface such as custom UI 1024 (e.g., implementing user interface 902 of FIG. 9). In some embodiments, the predictive deployment 1011 also cooperates with an LLM deployment 1032 (e.g., implementing monitored LLM endpoint 904 of FIG. 9) to support generating content based on predictive outputs and/or user inputs.

In the application deployment setup phase, an app execution environment 1026 is provisioned and one or more application assets are generated at 1028 (e.g., including user interface assets, prompt templates, content policies, and/or configuration for invoking the predictive

deployment 1011 and the LLM deployment 1032) to produce an app execution environment version 1030 that defines a versioned deployment configuration for the application. In some embodiments, endpoint identifiers for the predictive deployment 1011 and the LLM deployment 1032 are injected into runtime configuration associated with the app execution environment version 1030 to wire predictive and generative bundles for request servicing.

In the monitoring / real-time intervention setup phase, one or more custom metrics are configured and/or emitted, including completion tokens 1034, readability 1036, LLM cost 1038, and sentiment analysis 1040, which may be used to support monitoring dashboards, alerts, and/or runtime governance. The app execution environment version 1030 may then be used to deploy and/or update an application instance 1042 (“app from env”) that exposes the custom UI 1024 and services user requests using the deployed bundles.

### Computer-Based Implementations

Techniques operating according to the principles described herein may be implemented in any suitable manner. Included in the discussion above are flow charts showing the steps and acts of various processes for creating AI applications. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit, Field Programmable Gate Array (FPGA), or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one of ordinary skill in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including application software, system software, firmware, middleware, embedded code, or any other suitable type of software. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 1106 of FIG. 11 described below (i.e., as a portion of a computing device 1100) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Further, some techniques described above comprise acts of storing information (e.g., data and/or instructions) in certain ways for use by these techniques. In some implementations of these techniques, such as implementations where the techniques are implemented as computer-executable instructions, the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, including the exemplary computer system of FIG. 11, or one or more computing devices (or one or more processors of one or more computing devices) may be programmed to execute the computer-executable instructions. A computing device or processor may be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions may be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 11 illustrates one exemplary implementation of a computing device in the form of a computing device 1100 that may be used in a system implementing the techniques described herein, although others are possible. It should be appreciated that FIG. 11 is intended neither to be a depiction of all components for a computing device to operate in accordance with the principles described herein, nor a comprehensive depiction.

Computing device 1100 may comprise at least one processor 1102, a network adapter 1104, and computer-readable storage media 1106. Computing device 1100 may be, for example, a desktop or laptop personal computer, a personal digital assistant (PDA), a smart mobile phone, a server, a wireless access point or other networking element, or any other suitable computing device. Network adapter 1104 may be any suitable hardware and/or software to enable the computing device 1100 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 1106 may be adapted to store data to be processed and/or instructions to be executed by one or more processors 1102. Processor 1102 enables processing of data and execution of instructions. The data and instructions may be stored on the computer-readable storage media 1106.

The data and instructions stored on computer-readable storage media 1106 may comprise computer-executable instructions implementing techniques which operate according to the principles described herein. In the example of FIG. 11, computer-readable storage media 1106 stores computer-executable instructions implementing various facilities and storing various information as described above. Computer-readable storage media 1106 may store one or more of the facilities described herein (e.g., user interaction facility 102, AI logic facility 104, data facility 106, training facility 108, operations facility 110, etc.).

While not illustrated in FIG. 11, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

### Terminology

The terminology used herein is for the purpose of description and should not be regarded as limiting.

The term “approximately,” the phrase “approximately equal to,” and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

Measurements, sizes, amounts, etc. may be presented herein in a range format. The description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as 10-20 inches should be considered to have specifically disclosed subranges such as 10-11 inches, 10-12 inches, 10-13 inches, 10-14 inches, 11-12 inches, 11-13 inches, etc.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A computer-implemented method comprising:
receiving configuration file that selects, from a set of preconfigured application bundles, a subset of the application bundles and a set of configuration values;
generating a template instance that identifies the subset of the application bundles and specifies dependency relationships between at least some of the subset of the application bundles according to the set of configuration values;
determining, from the dependency relationships, an execution plan that orders provisioning and deployment actions for the subset of the application bundles;
provisioning, in accordance with the execution plan, execution resources for the subset of the application bundles in a deployment environment;
creating, for each application bundle in the subset, a respective managed bundle object comprising executable logic and a runtime configuration;
deploying each managed bundle object as a respective bundle endpoint onto the execution resources;
configuring communication between at least two of the bundle endpoints by propagating, into a runtime configuration of a dependent bundle endpoint, an identifier associated with an upstream bundle endpoint; and
exposing an application endpoint configured to receive a request and to invoke at least one bundle endpoint to generate a response.

2. The method of claim 1, wherein determining the execution plan comprises generating a dependency graph and ordering the provisioning and deployment actions based on the dependency graph.

3. The method of claim 1, wherein the subset of the application bundles comprises at least (i) an inference bundle configured to generate an AI output and (ii) an interface bundle configured to present the AI output via the application endpoint.

4. The method of claim 1, wherein the application endpoint is a bundle endpoint.

5. The method of claim 1, wherein the application endpoint is configured to route the request through a sequence of bundle endpoints according to an execution graph derived from the template instance.

6. The method of claim 1, wherein the application endpoint is further configured to provide a user interface that displays bundle-specific metrics for at least some of the managed bundle objects.

7. The method of claim 1, wherein the dependency relationships specify an execution order among at least two application bundles, and the runtime configuration of a downstream managed bundle object identifies an upstream deployed bundle endpoint from which an output is obtained as an input.

8. The method of claim 1, further comprising, after exposing the application endpoint:
receiving a modification to one of the managed bundle objects;
determining that the modification impacts at least one dependent managed bundle object based on the dependency relationships; and
selectively redeploying only the modified managed bundle object and the at least one dependent managed bundle object.

9. The method of claim 8, wherein selectively redeploying comprises replacing a deployed version of the modified managed bundle object with an updated deployed version while maintaining availability of the application endpoint.

10. The method of claim 1, further comprising:
establishing a credentialed connection to an external data source specified by the configuration values; and
configuring at least one managed bundle object to access the external data source via the credentialed connection.

11. A computing device comprising:
one or more processors; and
a non-transitory computer-readable medium storing instructions that, when executed by the one or more processors, cause the one or more processors to perform operations comprising:
receiving configuration file that selects, from a set of preconfigured application bundles, a subset of the application bundles and a set of configuration values;
generating a template instance that identifies the subset of the application bundles and specifies dependency relationships between at least some of the subset of the application bundles according to the set of configuration values;
determining, from the dependency relationships, an execution plan that orders provisioning and deployment actions for the subset of the application bundles;
provisioning, in accordance with the execution plan, execution resources for the subset of the application bundles in a deployment environment;
creating, for each application bundle in the subset, a respective managed bundle object comprising executable logic and a runtime configuration;
deploying each managed bundle object as a respective bundle endpoint onto the execution resources;
configuring communication between at least two of the bundle endpoints by propagating, into a runtime configuration of a dependent bundle endpoint, an identifier associated with an upstream bundle endpoint; and
exposing an application endpoint configured to receive a request and to invoke at least one bundle endpoint to generate a response.

12. The computing device of claim 11, wherein determining the execution plan comprises generating a dependency graph and ordering the provisioning and deployment actions based on the dependency graph.

13. The computing device of claim 11, wherein the subset of the application bundles comprises at least (i) an inference bundle configured to generate an AI output and (ii) an interface bundle configured to present the AI output via the application endpoint.

14. The computing device of claim 11, wherein the application endpoint is configured to route the request through a sequence of bundle endpoints according to an execution graph derived from the template instance.

15. The computing device of claim 11, wherein the application endpoint is further configured to provide a user interface that displays bundle-specific metrics for at least some of the managed bundle objects.

16. The computing device of claim 11, wherein the dependency relationships specify an execution order among at least two application bundles, and the runtime configuration of a downstream managed bundle object identifies an upstream deployed bundle endpoint from which an output is obtained as an input.

17. A non-transitory computer-readable medium storing instructions that, when executed by one or more processors of a computing device, cause the one or more processors to perform operations comprising:
receiving configuration file that selects, from a set of preconfigured application bundles, a subset of the application bundles and a set of configuration values;
generating a template instance that identifies the subset of the application bundles and specifies dependency relationships between at least some of the subset of the application bundles according to the set of configuration values;
determining, from the dependency relationships, an execution plan that orders provisioning and deployment actions for the subset of the application bundles;
provisioning, in accordance with the execution plan, execution resources for the subset of the application bundles in a deployment environment;
creating, for each application bundle in the subset, a respective managed bundle object comprising executable logic and a runtime configuration;
deploying each managed bundle object as a respective bundle endpoint onto the execution resources;
configuring communication between at least two of the bundle endpoints by propagating, into a runtime configuration of a dependent bundle endpoint, an identifier associated with an upstream bundle endpoint; and
exposing an application endpoint configured to receive a request and to invoke at least one bundle endpoint to generate a response.

18. The non-transitory computer-readable medium of claim 17, wherein determining the execution plan comprises generating a dependency graph and ordering the provisioning and deployment actions based on the dependency graph.

19. The non-transitory computer-readable medium of claim 17, wherein the application endpoint is configured to route the request through a sequence of bundle endpoints according to an execution graph derived from the template instance.
